(19) United States
(12) Patent Application Publication
(10) Pub. No.: US 2016/0260081 A1
(43) Pub. Date: Sep. 8, 2016

(54) SYSTEMS AND METHODS TO OPEN AND CLOSE THE ACCESS FOR THE AUTHORIZATION OF CHARGING A CHECKING ACCOUNT, SAVINGS ACCOUNT, MONEY MARKET ACCOUNT, CREDIT ACCOUNT, INVESTMENT ACCOUNT AND/OR A REWARD POINTS ACCOUNT THROUGH A MOBILE OR WEB APP.

(71) Applicant: Ricardo Zermeño, Guadalajara (MX)

(72) Inventor: Ricardo Zermeño, Guadalajara (MX)

(21) Appl. No.: 14/639,502

(22) Filed: Mar. 5, 2015

(51) Int. Cl. G06Q 20/32; G06Q 20/10; G06Q 20/20; G06Q 20/40; G06Q 20/38

(52) U.S. Cl. CPC G06Q 20/3224; G06Q 20/4014; G06Q 20/3227; G06Q 20/38215; G06Q 20/204; G06Q 20/1085

(57) ABSTRACT

Systems and methods to open and close the access for the authorization of charging a checking account, savings account, money market account, investment account, credit account and/or reward points account through an app for mobile devices or Web. It includes computer programming systems, methods and products to create a security system that authenticates the financial service users. The system is controlled remotely or on-site, a mobile device sends authorization information to the bank or financial institution for access to the user financial accounts, enabling these to keep active for a determined time span. A use method and system with two modes: pre-authorized access and access in real time.

### TECHNICAL FIELD

The current invention is related to the banking institutions field and its users in need of high security in their financial transactions, such as: charges for the collection of bearer or nominative checks, charges or disposition of investment funds and other securities, charges for online shopping, charges for shopping on POS terminals, charges for electronic transfer of funds, charges for direct debit payments, charges for cash withdrawal on ATMs and/or bank branches, and charges to a reward points account. Specifically in the part of authenticating the bank user and requesting its authorization to perform the operation and thus, preventing and avoiding frauds or money mismanagements.

### BACKGROUND KNOWLEDGE

Currently, there is an increase of frauds on banking transactions in any of its forms.

Prevention is less expensive and more effective than detecting or investigating a fraud when the money disappeared or the loss appeared, with few possibilities of recovery.

Fraud is a threatening phenomenon and its present in most organizations. Companies face many risks, fraud is one of them and like most risks, it can be hardly eliminated, but the probability of occurrence and relative costs can be limited.

Using a growing number of security systems through the implementation of the proper controls, these risks can be avoided, as long as banking security is one step forward from criminals.

Banking fraud is a crime perpetrated through the irregular use of the financial products commercialized by banks. Every charge to a bank account can be subject of fraud through the extraction of the people or institution confidential information. Due to the characteristics of this type of crime, banking or commercial institutions are assumed as the more frequent victims. The trend of theft of big databases with corrupt systems called malwares or pushing, puts at risk the entire global financial system.

The financial industry main problem resides in that their user's confidential information is exposed by the use of such information to perform different financial transactions.

In developing countries, financial transactions increase every year. Still, trading and banking businesses have unclear rules with major regulatory problems, this even causes that some companies that performed different transactions with banking or financial institutions, abandon this practice upon the fraud risk. This problem leaves these countries with a poor capacity of commercial growing, lagging their economies and losing the opportunity of future investments in the field of consumption.

### DETAILED DESCRIPTION

Systems and methods to open or close the access for the authorization of charging a checking account, savings account, money market account, credit account, investment account and/or a reward points account through a mobile or Web

App. In which the method is a series of features of our own invention, supported by authentication systems exclusively designed for these features.

The features of the present invention are applied to increase the security in bank and financial charges and transactions linked to any bank account of the financial users, such as: charges for the collection of bearer or nominative checks, charges or disposition of investment funds and other securities, charges for online shopping, charges for shopping on POS terminals, charges for electronic interbank transfers, charges for direct debit payments, charges for cash withdrawal on ATMs and/or bank branches, and charges to a reward points account.

The features of the present invention address the before mentioned needs and achieve other benefits, providing a series of systems for a mobile equipment or device and the method that allows a user to open or close the access for charges and transactions to its bank account when decided, without any other requirement. Some features of the present invention include authentication protocols for an electronic mobile payment device, a cell phone, an analog or digital phone, personal digital assistant, MP3 player, or portable computer, that can be configured to be used as a control and remote electronic communication device. The security protocol includes an authentication module that allows the user to authorize the processing center of bank transactions, or to financial institutions, or to the interfaces of POS devices or to the interfaces of the ATMs devices to provide free access, to validate all the information with its banking institution and to, also, open the access to achieve the feature of charges and transactions to their bank accounts for a predetermined time span, allowing that the transaction include the financial information of their accounts to a POS device interface, to a device interface or method of online or Internet payment, to a device or system interface for cash withdrawal, to the device interface or system of charges to bank accounts, to a prepaid account, or to any other type of account used for the payment of goods and services. The electronic device is equipped with a wireless communication interface configured to communicate information of the access authorization, to a payment terminal and/or to the server of a processing center of bank transactions, or to the server of financial institutions in general.

One feature of the invention is a Smartphone app or mobile device that stores the security protocol of the user. This app sends encrypted information to the device that receives the authorization to open or close the access to the user banking transactions, for a predetermined time and/or real time.

In all the features of authorization of open access to the charges and/or transactions, the user must authenticate its personality. The protocol refers to: authentication of the mobile device that the authorization comes from, authentication of the number of mobile app installed in your equipment, and authentication of the electronic signature or personal safety code.

In several features, the use of the mobile app includes security controls, such as and without limiting biometric validation, personal access code or any other mean to validate the user identity.

In a feature of the present invention, the method for processing any charge or transaction to the user banking accounts develops the following protocol: the processing center of bank transactions and/or the banking or financial institution, and/or POS, and/or ATM must permanently keep the user banking account on a “closed” status to any charge or bank transaction, second; in another feature of our invention; each time the user decides to make a charge or transaction to its banking accounts for any concept, must use our security protocol to “open” the authorization for applying charges or transactions to the type of selected account, before these are performed. In one feature of our invention, the user is offered the use mode of this system which we have called: pre-authorized access, its protocol keeps permanently closed the access to the banking accounts, without authorizing charges until the authenticated user opens the access for the charges or transactions execution that are about to be performed. In another feature of our invention, once the access to charges or transactions is authorized, these must be performed for a time span previously selected that goes from 1 second to 24 hours, after any charged is performed or the selected time passes, the access to the bank account is closed again, not allowing any charge or transaction to that account without the above mentioned authorization process. On another feature of our invention, it allows that the user receives a notification of attempt of charge, to be authorized in real time, this notification informs the type of charge, which account the funds will be charged to, the amount, the company or business that will receive the funds and date. These modes allow the user to use them each time it decides to perform a charge to its account before these are processed. This method operates through an app for mobile devices, web and bank, commercial and/or financial servers.

On one feature of our invention, the innovation allows that the user of the bank accounts and through an app to its cell phone or any other device, open or close the access to authorizations for charges or transactions to its bank accounts, allowing top control of its money. On another feature of the invention, it allows the user to legally recognize the charges or transactions to its bank accounts.

On some features, the security protocol includes a permission and an authentication module. The method provides a security system for the financial transaction. The authorization module includes bi-directional encrypted information; between the mobile app and the processing center of bank transactions and/or the financial institution, the POS device, the ATM device and vice versa. On another feature of the present invention, the permission protocol and the authentication module permission are developed by means of another feature: the TRILE encryption that is formed of the following elements: a coded alphanumerical chain with fixed values and a coded alphanumerical chain with variable values. This is where the fixed values that are coded, were obtained by the addition of several factors, including the following: the cell phone number, plus the equipment or mobile device IMEI code, plus the app unique individual code that was provided when it was downloaded to the mobile device, plus the user security code. The variable values can be the transaction request hour and minute, or data via Bluetooth, or data via infrared rays system or data via Near field communication that generate coded information.

On one feature of the invention, we created the procedure to code bi-directional information data; between the mobile device and the financial, bank or commercial devices. Here, all the information is coded in a unique alphanumerical chain for each authorization to open the access to charges and financial transactions of the accounts selected by the user. On one feature of this invention, if the user has properly authenticated its identity, the system transfers bi-directional information of its banking or financial accounts. On another feature, the system wirelessly transfers financial information and authorization for free access of charges to its bank accounts: to the server of the processing center of bank transactions, to the server of the financial institutions, to the interface of the POS devices, or to the interface for the cash withdrawal on ATM devices, or to the interface of the portable computer device so the financial transactions are performed freely without any other requirement, except for the standard requirements applied to this type of operations. On some feature forms, the system includes: a computer system, like a mobile phone, a PDA, a keychain, watch, computer, server, network interface device, such as Near field communication, a Bluetooth device, a radio frequency (RFID) device and other device capable to interact with the response network. The network can be a global area network (GAN), like the Internet, a wide area network (WAN), a local area network (LAN), a Wi-Fi network, a 3G network or any other type of network and combination of networks. The network can be cable or wireless provided, or a combination of fixed and wireless phone service between the network devices.

The processing device, a term that includes circuits used for the execution of the communication and/or logical functions of a system. As an example, a processing device can include a digital signal processing device, a micro processing device and several analog to digital converters, digital to analog converters and other support circuits and/or the combination of the above.

Control functions and signal processing of system signals are assigned between these processing devices, these can include the function to operate one or more software programs based on computer readable instructions, that can be stored on a memory device. The processing device is operationally coupled to the communication device and to the memory device. The processing device uses the communication device to communicate with the user, also the processing device uses the network interface to communicate with the network and other network devices, such as, but not limited to; the bank transaction processing center and its database, the bank or financial institution database, the POS database, to the cash withdrawal point database, the databases of the companies specialized on collection and payment systems.

The security system of the financial institution includes computer readable instructions and the app or mobile device stored in files, that in one feature of this invention, includes the computer readable instructions of the security protocol app. On one featured feature, most of these specifications are described, the security protocol app allows the communication between the communication module and a transaction module, an authorization module and an authentication module to send, receive, store information related to the transaction security system, to determine the authorization details of opening the access to charges and transactions to the user accounts, and in when this access must be closed.

On some features, the communication module also controls the network interface to ease the communication with the user financial institution, other users and the POS or transaction point. On some features, the user communication module or device exchanges information with the transaction or POS module, determines that the user is trying to make a transaction and determines if the user bank accounts have open or close access for this transaction and acts accordingly.

On another feature of this invention, the bi-directional communication means is a text message to an encrypted cell phone with authentication protocol.

It is also included on some features a power supply and a timer. On another feature, the system uses an accelerometer. On another feature, the system functions without electric power on board, if the electric power supply is configured to receive power from a POS device or a financial transaction device.

On some features, this invention can perform as a method; a process implemented as a computer configuration, a business process, any other process. For its function, support it with devices, systems, machines, computer program or similar products and/or a combination of the above. Therefore, the features of this invention, can take the form of a totally software feature, including without limitation; firmware, resident software, micro code and some combinations of the above. For example, some features can take the form of computer software through the web. The features of this invention can take the form of a computer program product over a computer readable means that has a code for an attached computer executable program. The computer readable means can include but is not limited to: a non transitory computer readable means, such as an electronic, magnetic, optical, electro-magnetic, infrared and/or semiconductor tangible system, the device or another equipment. For example, on some features, the non transitory computer readable means includes a tangible means such as; a portable computer diskette, a hard disk, a RAM memory, a ROM memory, a CD-ROM memory and some optical and/or tangible magnetic storing devices. One or more parts of the computer executable program code to perform the functions of this invention can include object-oriented languages and/or object oriented programming languages, such as: Java, Perl, Smalltalk, C++. SAS. SQL, Phyton, Objective C and/or similar.

On one feature of this invention, the user communication module, receives the information from the financial institution or from the processing center of bank transactions or from the company specialized on collection or payment, that received a request with an attempt of charge, being the account with the access closed, requesting its authorization to open the access in real time and the authorization of charge to its bank account for concept of, maybe; recurring direct debit payment. This notification of authorization request is validated with the security protocol described, by authenticating the user; if this accepts the charge, just adds its personal security code and the charge acceptance and the transaction is authorized. If it is not authorized, it is automatically reported as an attempted fraud, cancelling immediately the check or credit or debit cards, or the financial documents linked to this attempt.

On the feature of our invention, it strengthens the security of this type of operations, since the access to the bank accounts keeps closed to any charge, and can be only open whenever the authenticated user wants, without any other control or requirement.

On another feature of this invention, each attempt of a financial operation; whether is a charge through a check, electronic transfer of funds, or uses the credit card in any POS, cash withdrawal on ATMs and recurring direct debit payments, requires an authorization of previous access or an authorization of access in real time to be processed.

On another feature of this invention, a multifactorial authentication of the user is validated for a correct authorization of the said request and charge authorization.

On one feature of our invention, our authentication system, through the user communication device, sends the information needed to the processing center of bank transactions, to the server of its banking institution, to the POS or ATM device to request the authorization of this transaction to the bank institution with the certainty that the user was authenticated and that authorization of free access is valid.

On one feature of this invention, we detail the method and system to open or close the access to the charge or transactions authorization to a bank account:
(1) On some features, the user obtains the app for its mobile device or web offered by its banking or financial institution.
(2) On one feature, the bank user configures the mobile device app, customizing some parameters that serve to conform the user authentication module and the authentication of its mobile device or web and the type of bank accounts registered in the mobile device.
(3) On another feature, the mobile app develops the algorithm with an alphanumerical chain composed by fixed and variable values: these can be combined or used interchangeably; user personal code, encrypted information of the mobile device or web, hour and minute, device geo localization, the time of the charge or transaction request hour comparing them to the authentication values and analyzing the predetermined time that the access must be open to the charges or transactions.
(4) On one feature of this invention, the user uses the app on its cell phone or mobile device, for this it is necessary to fulfill the security protocol.
(5) On one of the features of this invention, the user selects the authorization method: the pre-authorized access mode.
(6) On one feature, when selecting the pre-authorized mode, it is reminded that this mode will open the bank account selected for a time span that goes from one second up to 24 hours and allows to authorize the first charge or transaction during that period, subsequently to the applied charge or to the predetermined time passes, the mobile app sends the authorization to the server of the processing center of bank transactions to close the account again.
(7) On other features, when the user attempts to perform any transaction with charge to its bank account, for example a purchase in a POS with a bank terminal, an online purchase, a purchase through any Internet device, the cash withdrawal in ATM, the recurring direct debit payment or any other transaction with charge to any of its bank accounts, the information of this request is sent via that means to the processing center of bank transactions or to the financial institution, or to the company specialized on online collection or payment to be validated.
(8) On one feature, the server of the processing center of bank transactions or the financial institution, or POS, or the ATM device, verifies if the user account has open access pre-authorized for charges or transactions.
(9) On another feature, if the access is closed, authorization is requested to the user to open the access in real time, if the user refuses to recognize that attempt of charge or transaction, the operation is cancelled.
(10) On one feature of this invention, if the access is open, it was because the authorization of the user authenticated by the security protocols was received.
(11) On another feature, the app of the user mobile device was authenticated with the security protocols, the user sends the access authorization, also, informs the time span selected to keep the access open for charges or transactions.
(12) On another feature of this invention, the inclusion of the security code by the bank user to the security protocol, finally enables to authenticate that the user accepted and authorized that operation and the charge to its bank account.
(13) On one feature of this invention, the bank or commercial institution server identifies the authentication to validate the authorization of the bank user, approves the transaction and this is executed. After a charge or transaction, the access is closed again.
(14) On another feature, the bank or commercial institution server sends to the app of the bank user mobile device, the notification with the information of transaction type, payment recipient, amount and date.
(15) The system sends an informative notification to third parties involved in that operation.

### Best Systems and Methods Known for the Invention

Systems and methods to open or close the access for the authorization of charging a checking account, savings account, money market account, investment account, credit account and/or reward points account through an app for mobile devices or Web, used on the following transactions:
I. Transactions on Bank Website (Online Banking Services) such as electronic transfers (Interbank electronic payments), movements, utilities payments, etc.
II. Transactions for purchasing on Internet Websites (Online purchasing) with credit cards, Debit cards and cash withdrawal from a checking account.
III. Transaction on ATM with Credit card or Debit card.
IV. Transaction from a POS with Credit card, Debit card or a Department Store Credit card.
V. Transactions from check collecting on banking institutions.

I. Systems and methods to open or close the access for the authorization of charging a checking account, savings account, money market account, investment account, credit account and/or reward points account through an app for mobile devices or Web in an electronic transfer transaction. Example of Transaction from electronic transfer:
1. The online banking user has access to its bank or commercial website.
2. The user chooses which type of mode prefers to authorize the access for charging its bank account: The pre-authorized mode or the access mode in real time.
3. The bank user programs a movement on its bank website.
4. The bank website requests authorization to the processing center of bank transactions responsible for the transaction to validate with the bank institution, account information, balance, operation amount, requesting bank, etc.
5. The bank validates and sends the information to the server of the processing center of bank transactions responsible of this operation.
6. The server of the processing center of bank transactions checks the user account statement, if this is “open”, proceeds to the validation standard system for the operation, without any other requirement. If the user account is “closed”, then sends the notification of authorization request to the user mobile device app, containing all the charge data; amount, date and funds receiver.
7. The app executes the high security authentication system and method.
8. The notification of authorization request to perform the charge to its bank account is visualized in the bank user app, with all the information needed.
9. The bank user accepts or refuses the transaction, if accepts, it must fulfill the security protocol, by writing its personal security code.
10. The processing center of bank transactions responsible for the transaction, validates the user response.
11. The server of the processing center of bank transactions responsible for the transaction, validates the operation, with its security models and authorizes the charge.
12. The server of the processing center of bank transactions responsible for the transaction sends information to the bank or financial institution to perform the due deduction to the funds from the user bank account, who in turn sends the validation to the bank website with the transaction approval.
13. The transaction is successfully performed.
14. The server of the processing center of bank transactions responsible for the transaction sends the informative notification of the transaction through the same mobile app.
   See FIG. 2.

II. Systems and methods to open and close the access for the authorization of charging a checking account, savings account, money market account, investment account, credit account and/or reward points account through an app for mobile devices or Web in a transaction and/or use in websites (Online purchasing) with credit cards, debit cards and dispersion of funds from a checking account.

Example of Transaction and/or its use on websites (Online purchasing) with Credit cards, Debit cards and dispersion of funds from a checking account:
1. The user enters to a website to purchase.
2. The use enters its Credit or Debit card information.
3. The user chooses the type mode preferred to authorize the access to the charge to its bank account: The pre-authorized access mode or the access in real time mode.
4. The purchasing website requests authorization to the processing center of bank transactions responsible for the transaction to validate with the bank institution, card data, operation amount, requesting bank, etc.
5. The bank validates and sends the information to the server of the processing center of bank transactions responsible for the operation.
6. The server of the processing center of bank transactions, or the purchasing website checks the user account statement, if it is “open”, proceeds to the proceeds to the validation standard system for the operation, without any other requirement. If the user account is “closed”, then sends the notification of authorization request to the user mobile device app, containing all the charge data; amount, date and funds receiver.
7. The app executes the high security authentication system and method.
8. The notification of authorization request to perform the charge to its bank account is visualized in the bank user app, with all the information needed.
9. The bank user accepts or refuses the transaction, if the user accepts, then the user must fulfill the security protocol by writing its personal security code.
10. The processing center of bank transactions responsible for the transaction, validates the user response.
11. The server of the processing center of bank transactions or the purchasing website responsible for the transaction, validates the operation, with its security models and authorizes the charge.
12. The server of the processing center of bank transactions responsible for the transaction sends information to the bank or financial institution to perform the due deduction to the funds from the user bank account, who in turn sends the validation to the purchasing website terminal with the transaction approval.
13. The transaction is successfully performed.
14. The server of the processing center of bank transactions responsible for the transaction sends the informative notification of the transaction through the same mobile app.
   See FIG. 3.

III.—Systems and methods to open and close the access for the authorization of charging a checking account, savings account, money market account, investment account, credit account and/or reward points account through an app for mobile devices or Web on an ATM transaction.

### Example of Transaction on an ATM:

1. The user attempts to withdraw cash in an ATM.
2. The user chooses the type mode preferred to authorize the access to the charge to its bank account: The pre-authorized access mode or the access in real time mode.
3. The user enters the card into the ATM.
4. The user types its confidential PIN in the ATM.
5. The ATM provides access to its account.
6. The ATM system requests authorization to the processing center of bank transactions responsible for the transaction to validate with the bank institution, card data, balance, operation amount, requesting bank, etc.
7. The bank validates and sends information to the server of the processing center of bank transactions responsible for the transaction.
8. The server of the processing center of bank transactions, or the ATM electronic device checks the user account statement, if it is “open”, proceeds to the validation standard system for the operation, without any other requirement. If the user account is “closed”, then sends the notification of authorization request to the user mobile device app, containing all the charge data; amount, and date.
9. The app executes the high security authentication system and method.
10. The notification of authorization request to perform the charge to its bank account is visualized in the bank user app, with all the information needed.
11. The bank user accepts or refuses the transaction, if the user accepts, then the user must fulfill the security protocol by writing its personal security code.
12. The server of the processing center of bank transactions responsible for the transaction sends information to the bank or financial institution to perform the due deduction to the funds from the user bank account, who in turn sends the validation to the ATM with the transaction approval.
13. The ATM executes the transaction.
14. The server of the processing center of bank transactions responsible for the transaction sends the informative notification of the transaction to user through the same mobile app.
   See FIG. 4.

IV. Systems and methods to open and close the access for the authorization of charging a checking account, savings account, money market account, investment account, credit account and/or reward points account through an app for mobile devices or Web from a transaction in a POS.

### Example of Transaction in POS:

1. The user is in a store with a POS where the payment is made with a Credit, Debit or Department Store Credit card.
2. The user chooses the type mode preferred to authorize the access to the charge to its bank account: The pre-authorized access mode or the access in real time mode.
3. The bank terminal requests authorization to the processing center of bank transactions responsible for the transaction to validate with the bank institution, card data, balance, operation amount, requesting bank, etc.
4. The bank validates and sends information to the server of the processing center of bank transactions responsible for the transaction.
5. The server of the processing center of bank transactions, or the electronic device of the POS terminal checks the user account statement, if it is “open”, proceeds to the proceeds to the validation standard system for the operation, without any other requirement. If the user account is “closed”, then sends the notification of authorization request to the user mobile device app, containing all the charge data; amount, date and funds receiver.
6. The app executes the high security authentication system and method.
7. The notification of authorization request to perform the charge to its bank account is visualized in the bank user app, with all the information needed.
8. The bank user accepts or refuses the transaction, if the user accepts, then the user must fulfill the security protocol by writing its personal security code.
9. The processing center of bank transactions responsible for the transaction, validates the user response.
10. The server of the processing center of bank transactions or the POS terminal device responsible for the transaction, validates the operation, with its security models and authorizes the charge.
11. The server of the processing center of bank transactions responsible for the transaction sends information to the bank or financial institution to perform the due deduction to the funds from the user bank account, who in turn sends the validation to the POS terminal with the transaction approval.
12. The server of the processing center of bank transactions responsible for the transaction sends the informative notification of the transaction to the bank user through the same mobile app.
   See FIG. 5.

V. Systems and methods to open and close the access for the authorization of charging a checking account, savings account, money market account, investment account, credit account and/or reward points account through an app for mobile devices or Web in a transaction from check collecting.

Example of Transaction from check collecting:
1. A check is stolen or a check is attempted to be collected for an amount greater when the check information is modified.
2. The criminal tries to collect the check in a financial institution.
3. The bank institution requests authorization to the processing center of bank transactions responsible for the transaction to validate with the bank institution, account data, operation amount, requesting bank, etc.
4. The bank validates and sends information to the server of the processing center of bank transactions responsible for the operation.
5. The server of the processing center of bank operations checks the user account statement, if it is “open”, proceeds to the proceeds to the validation standard system for the operation, without any other requirement. If the user account is “closed”, then sends the notification of authorization request to the user mobile device app, containing all the charge data; amount, date and funds receiver.
6. The app executes the high security authentication system and method.
7. The notification of authorization request to perform the charge to its bank account is visualized in the bank user app, with all the information needed.
8. The bank user accepts or refuses the transaction, if the user accepts, then the user must fulfill the security protocol by writing its personal security code.
9. The processing center of bank operations responsible for the transaction, validates the user response.
10. The server of the processing center of bank operations responsible for the transaction, validates the operation, with its security models and authorizes the charge.
11. The server of the processing center of bank operations responsible for the transaction sends information to the bank or financial institution to perform the due deduction to the funds from the user bank account, who in turn sends the validation to the bank website with the transaction approval.
12. The check is collected in the bank institution or the person that attempted fraud is arrested.
13. The server of the processing center of bank operations responsible for the transaction sends the informative notification of the transaction to the user through the same mobile app.
   See FIG. 6.

### BRIEF DESCRIPTION OF FIGURES

FIG. 1 is a method view to open or close the access for the authorization of charges to a checking account, savings account, money market account, investment account, credit account and/or reward points account through an app for mobile devices or Web in a check collection transaction.

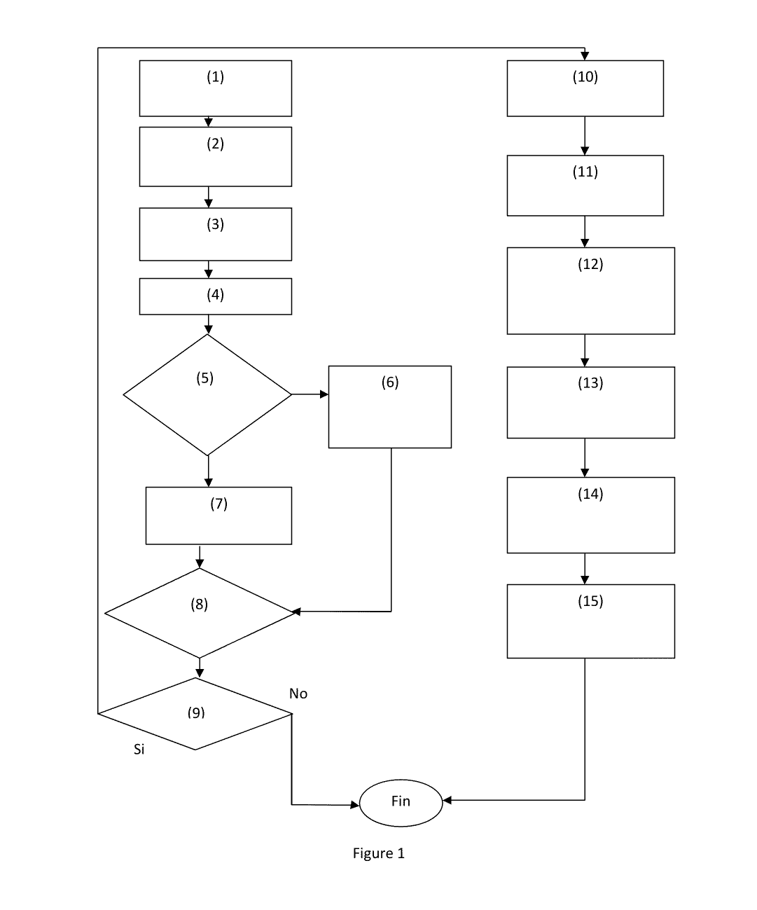

FIG. 2 is a graphic view of the participants in the transaction process in a bank website (Online Bank Services) such as electronic transfers (Interbank electronic payments), movements, utilities payment.

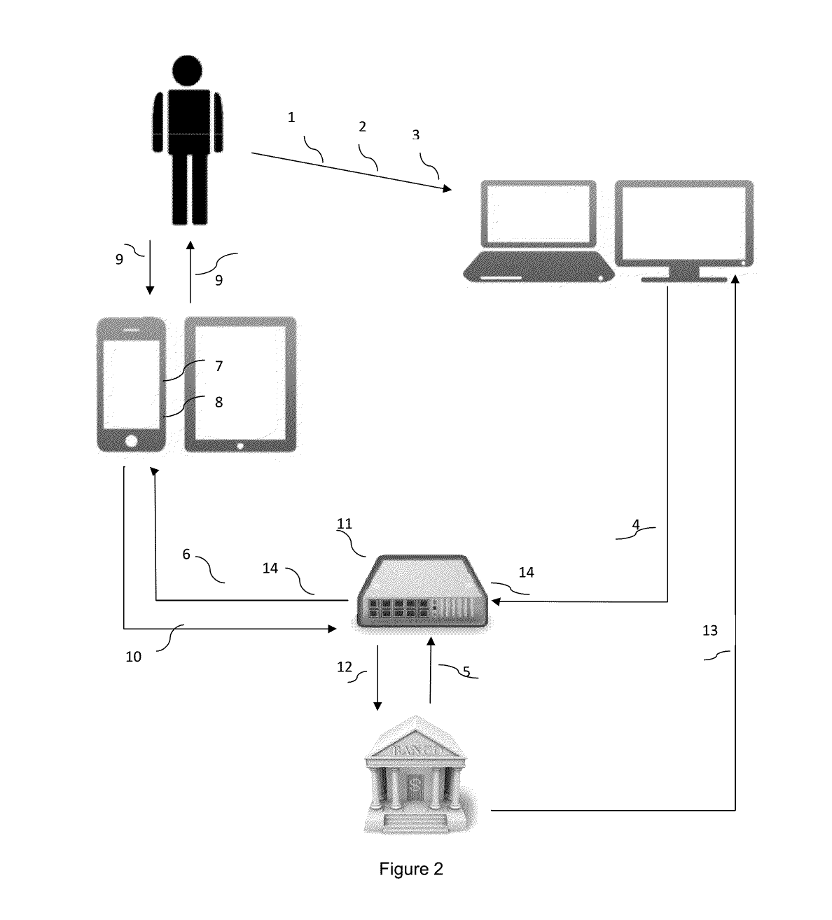

FIG. 3 is a graphic view of the participants in the transaction process for purchasing on Internet Websites (Online purchasing) with credit and Debit cards.

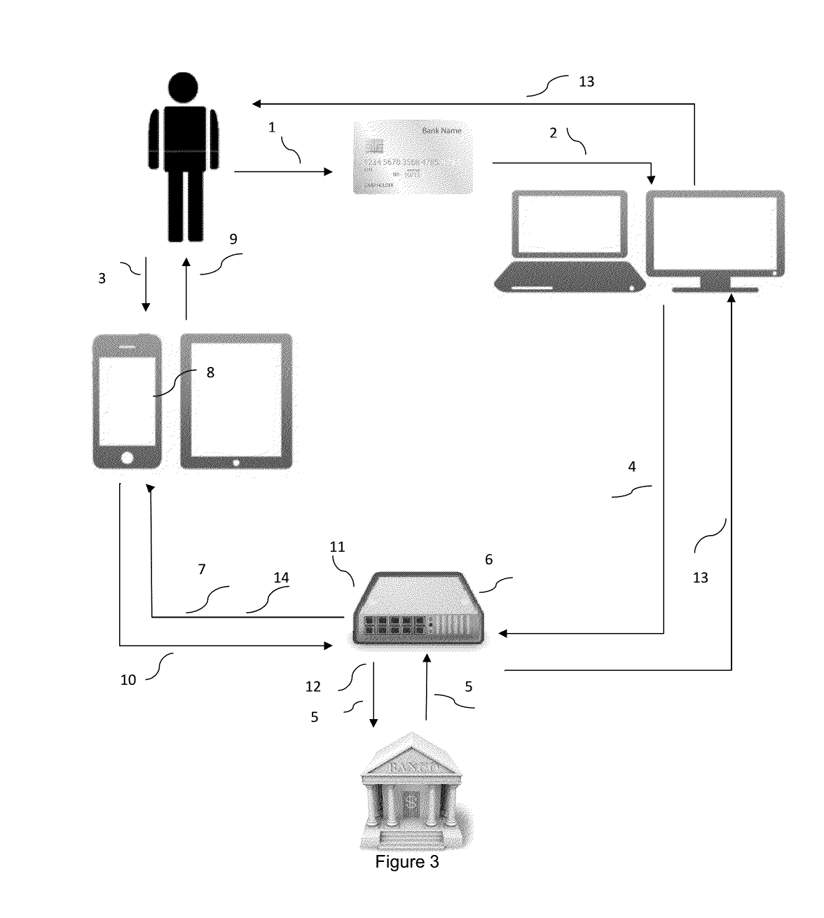

FIG. 4 is a graphic view of the participants in the transaction process from a POS with Credit card, Debit card or a Department Store Credit card.

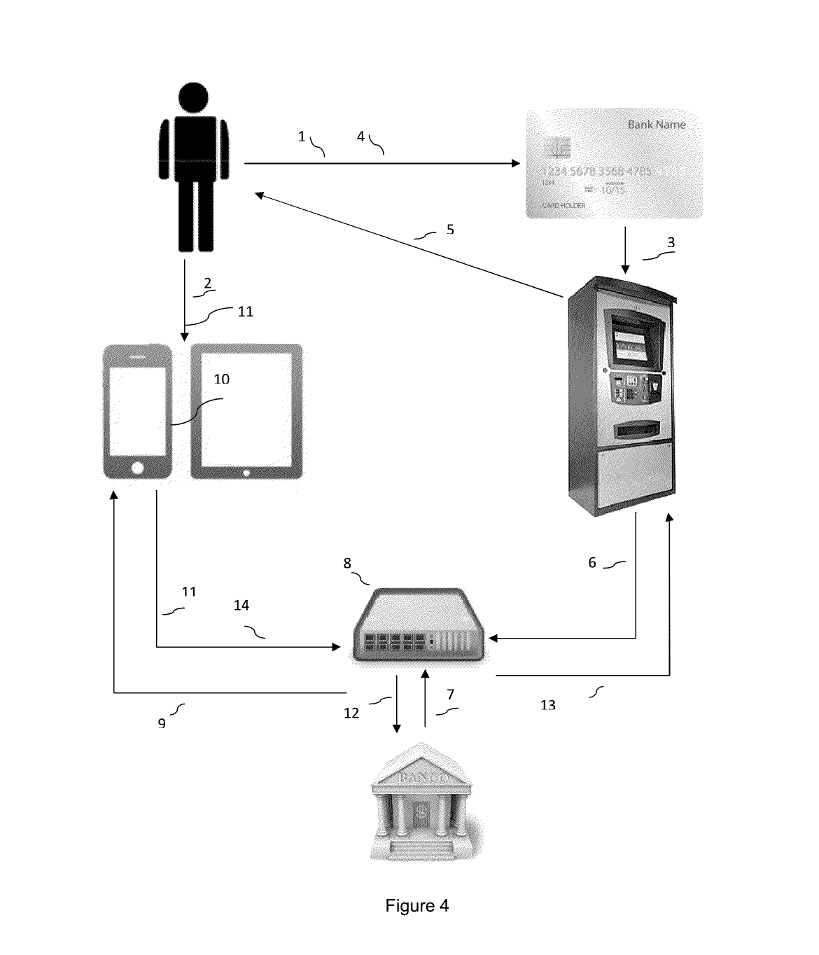

FIG. 5 is a graphic view of the participants in the transaction process on ATM with Credit or Debit card.

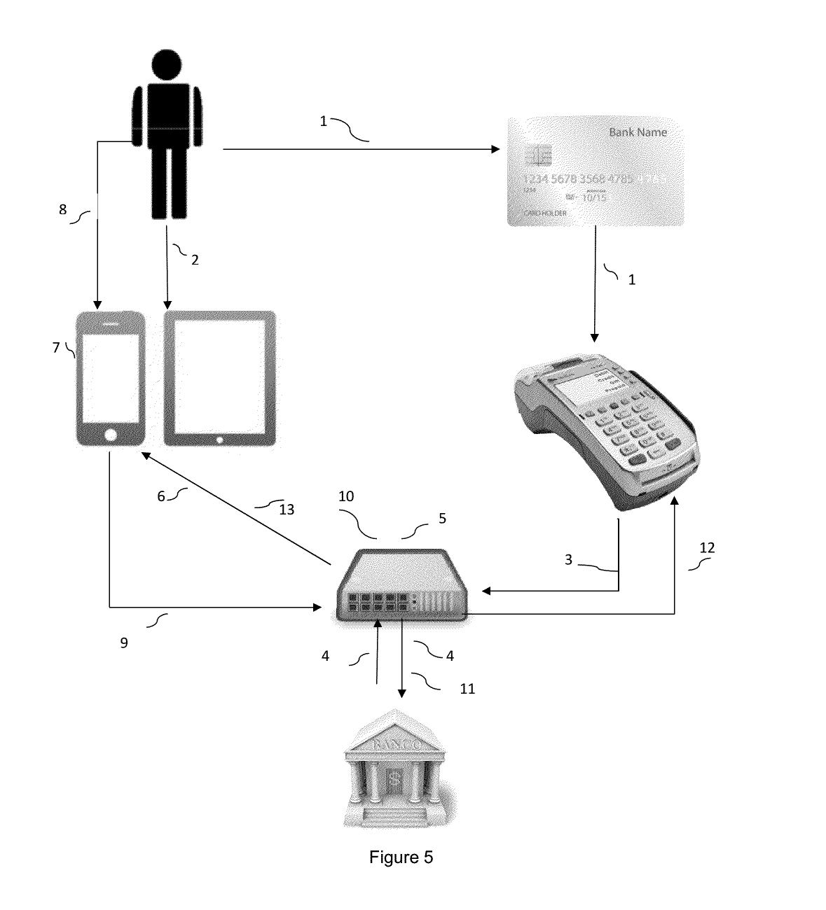

FIG. 6 is a graphic view of the participants in the transaction process from check collecting on banking institutions.

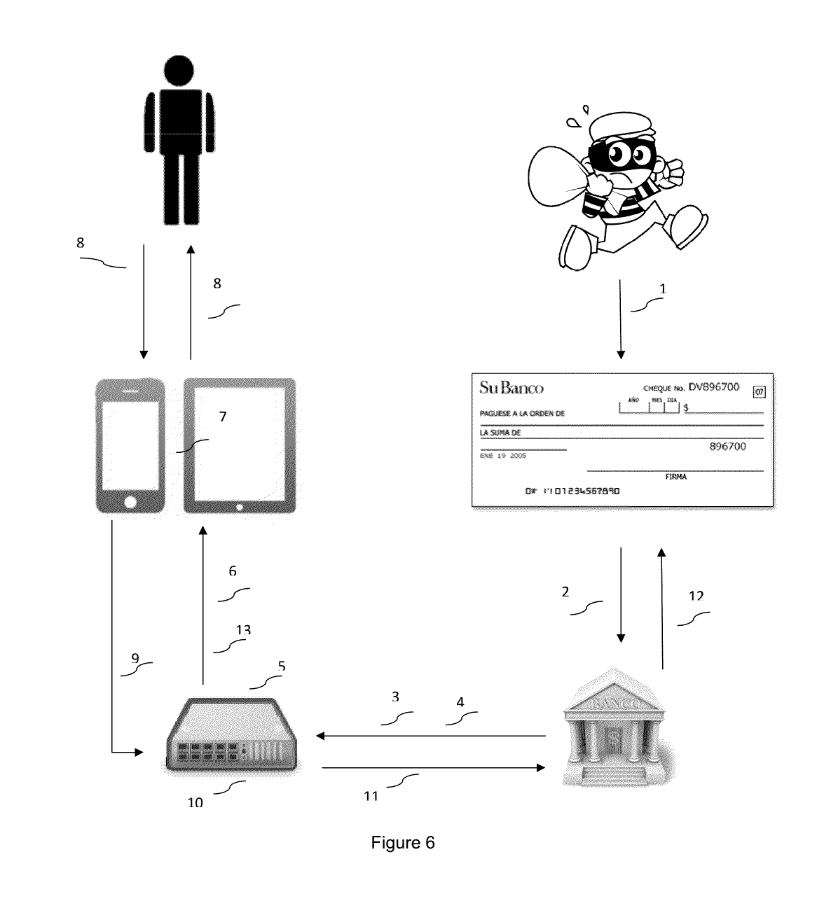

What is claimed is:

1. A system that allows the user to open or close the access for charges or transactions in their bank accounts remotely, that comprises a first transaction and/or command communication device, including an information processor to determine the user authentication, a processor to transmit the authorization to open or close the account access, a transmitter to transmit the user localization, a second receiving device to receive the identity information, a transmitter to transmit the access authorization, a receiver to process the user authorization. The system comprises the security of the mobile transactions device; a memory device; a communication device; and a processing device that is configured to receive the user security protocol that comprises an authentication module and an authorization module to open or close the access for charges or transactions to its bank or financial accounts.

2. The claiming system 1, where the first transaction device includes a transmitter to transmit the identification. A second transaction device includes a receiver to receive the identification, and a transaction processor that is configured to authenticate the identification.

3. The claiming system 1, in the system includes a configuration to refuse the transaction in the second transaction device, when the first and/or second device determine a non valid authentication.

4. The claiming system 1, in which the first transaction device and the second transaction device are configured to generate the respective encrypted codes to; encrypt and/or decrypt the identity information before transmitting financial information.

5. The claiming system 1, where the first transaction device and the second transaction device are the cell phones configured to mutually authenticate each other over the base of information through a cell network.

6. The claiming system 1, where the first transaction device is a cell phone and the second transaction device is a financial or commercial server configured to mutually authenticate each other over the base of information through a cell or radio frequency network.

7. The claiming system 1, where the first transaction device is a cell phone or a Bluetooth device, or a Near field communication device and the second transaction device is a POS terminal or ATM machine configured to mutually authenticate each other over the base of information through a cell or radio frequency network.

8. The claiming system 1, where the authentication module comprises at least one security feature.

9. The claiming system 1, where the security feature is composed of, at least: the user name, or a personal password, or a security question, or biometric recognition.

10. The claiming system 1, where the communication device can be one that uses: a keyboard, a scanner, a touch screen, a camera, a cell phone, a radio frequency device and/or a mobile device.

11. The claiming system 1, in which one of the transaction features consists of identifying the user to enable it to authorize the access to the charges or transactions to its bank or financial account remotely or on-site.

12. The claiming system 5, 6 and 7, where the first transaction device transmits the identity and authentication for the second transaction device to resend the identity and authentication to a data processing center or to the financial transaction processing center.

13. A system composed by several configured computer program devices or products an improvement in the security in the financial transactions that comprises; a data processor configured to determine the “open” or “close” status, the access to charges or transactions of a bank, financial or commercial account.

14. The claiming system 9, a processor configured over the database of a server of financial transactions processing center or to a bank institution server.

15. The claiming system 9, a processor configured over the POS terminal device database.

16. The claiming system 9, a processor configured over the ATM server database.

17. A procedure implemented in a computer and/or several devices to provide the following method characterized by the reception of the security protocol of a user, the security protocol comprises an authorization module to a command and one authentication and processing module. Where the authentication and processing module comprises instructions about when the user bank account access is on “closed” status and when it is on “open” status to allow or not, financial transactions on that account. This module processes the authentication and authorization to open the access, but also has the authorization to close the access after a transaction or after the time predetermined by the user passes. This same module processes authorization notifications so that the user opens the access to its account in real time.

18. The claiming system 17, in which the user uses the app to open the access to charges to its account, in which the authentication module comprises at least one security feature: personal password, biometric recognition or mobile device localization.

19. The claiming system 17, in which determines that the user is authorizing free access of charging its account in one specific time or to any hour selected by the user, setting a predetermined time of 10 minutes for opening the access to its account to any transaction.

20. The claiming system 17, in which determines that the user in the authorized time span, is performing a transaction, comprises to receive or transmit a sales device signal, an ATM device signal, a computer device or signal to be processed in the same devices or being sent to the server of the financial transactions processing server or to the user bank institution.

21. The claiming system 17, as long as enables the transaction comprises the information transfer of the user account to the different devices or to the processing center server.

22. The claiming system 17, in which the different devices or the processing center server determine the status of the user bank account which, in this case, is “open”, all the transactions is executed with the standard procedures, without any other requirement.

23. The claiming system 17, in which when the authorized transactions is ended by free access, an authorization to close again the access to that bank or financial account is automatically generated.

24. The claiming system 17, in which the assumption that the user did not previously open the access to its bank account is determined; the operation is stopped until requesting to the user the authorization to open the access in real time.

25. The product of a computer program to provide a financial transaction security module, comprising as a product, the computer readable means with a non transitory comprehension: the executable part to make that the computer receives the user security protocol, the security protocol that comprises a permission or authorization module and a authentication module, in which the authentication and processing module comprises the instructions of when the user bank account is in “closed” or “open” status to the access to charges or financial transactions and when it must be automatically closed.

26. The computer program product of claiming 25, to be installed in a POS interface, or in an ATM interface, or in a computer or mobile device interface, to a server of the financial transactions processing center and/or a bank institution server.

27. The computer program product of claiming 25, in which the memory storages have at least, the information associated to the checking account, or savings account, or the money market account, or to the credit account or to the investment account and/or to the reward points account to the user.

28. The computer program product of claiming 25, in which the user authentication or authorization module, allows to be used wirelessly or remotely, or on-site to open the access to its accounts for charges or transactions.

29. The computer program product of claiming 25, in which the user authentication or authorization module, uses an encrypted text message to authorize the access to its accounts for charges or transactions.

30. The computer program product of claiming 25, a procedure implemented in a computer and/or several devices to provide financial information security, comprising the following method characterized by the reception of a security protocol from a user, this security protocol is composed by an authorization module to a command and one authentication and processing module; in which the authentication and processing module is developed in a company that stores credit information from the user, and that understands instructions about when a financial, banking or commercial entity requests information to grant a credit to the user's name, this information is notified and its authorization is verified, preventing frauds due to identity theft.
